(19) United States
(12) Patent Application Publication
(10) Pub. No.: US 2010/0232695 A1
(43) Pub. Date: Sep. 16, 2010

(54) VIDEO SIGNAL PROCESSING APPARATUS AND COMPUTER-READABLE RECORDING MEDIUM HAVING RECORDED THEREIN VIDEO SIGNAL PROCESSING PROGRAM

(75) Inventor: Keiji Higuchi, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 12/773,272

(22) Filed: May 4, 2010

Related U.S. Application Data
(63) Continuation of application No. PCT/JP2008/070476, filed on Nov. 11, 2008.

(30) Foreign Application Priority Data
Nov. 15, 2007 (JP) 2007-296890

(51) Int. Cl. G06K 9/00

(52) U.S. Cl. 382/167

(57) ABSTRACT

An excellent image is obtained by performing a noise reduction process taking into account a color component. By performing color space conversion on a color video signal, a first color converted signal is generated. By performing color space conversion on a color video signal of a past frame, a second color converted signal is generated. A noise-reduced signal is generated from the first color converted signal and the second color converted signal. The noise-reduced signal is subjected to inverse conversion.

### CROSS REFERENCE TO RELATED APPLICATIONS

This is a continuation of International Application PCT/JP2008/070476, with an international filing date of Nov. 11, 2008, which is hereby incorporated by reference herein in its entirety.

### TECHNICAL FIELD

The present invention relates to a video signal processing apparatus and a computer-readable recording medium having recorded therein a video signal processing program, which are suitable to perform noise reduction on a color video signal.

This application is based on Japanese Patent Application No. 2007-296890, the content of which is incorporated herein by reference.

### BACKGROUND ART

For example, Japanese Unexamined Patent Application, Publication No. 2001-197321 discloses a method in which read digital data of three primary colors is color-converted to an HSV color system represented by a hue H axis, a saturation S axis, and a value V axis, and a smoothing process is performed on the data on at least one of the value V axis and the saturation S axis.

In addition, for moving images, Japanese Unexamined Patent Application, Publication No. 2004-88234 discloses a method in which a frame recursive noise reduction apparatus detects motion and combines pixels of an immediately previous frame and of a current frame using a recursive coefficient set according to a motion component.

Patent Citation 1:

Japanese Unexamined Patent Application, Publication No. 2001-197321

Patent Citation 2:

Japanese Unexamined Patent Application, Publication No. 2004-88234

### DISCLOSURE OF INVENTION

The color trend may be unbalanced depending on a target to be shot. For example, when the inside of a human body is shot using an endoscope, the resulting image contains more red, yellow, and white. In this case, for these colors, great importance is placed on resolution.

The present invention provides a video signal processing apparatus and a computer-readable recording medium having recorded therein a video signal processing program, which can obtain an excellent image by performing a noise reduction process taking into account a color component.

A first aspect of the present invention relates to a video signal processing apparatus that performs signal processing on an inputted color video signal on a frame-by-frame basis, the video signal processing apparatus including:

a first color space converting unit that performs color space conversion on the color video signal and thereby generates a first color converted signal;

a second color space converting unit that performs color space conversion on a color video signal of a past frame and thereby generates a second color converted signal, the past frame being any frame previous to a target frame to be processed in the first color space converting unit;

a color space conversion method determining unit that determines a color space conversion method which is performed by the first color space converting unit and the second color space converting unit;

a noise reducing unit that performs a noise reduction process based on the first color converted signal and the second color converted signal, and thereby generates a noise-reduced signal; and

an inverse color space converting unit that performs inverse conversion on the noise-reduced signal, based on the color space conversion method determined by the color space conversion method determining unit.

A second aspect of the present invention relates to a video signal processing apparatus that performs signal processing on an inputted color video signal, the video signal processing apparatus including:

a color space conversion method determining unit that determines a color space conversion method for the color video signal;

a color space converting unit that converts the color video signal using the color space conversion method determined by the color space conversion method determining unit, and thereby generates a color converted signal;

a noise reducing unit that performs a noise reduction process based on the color space conversion method and the color converted signal, and thereby generates a noise-reduced signal; and

an inverse color space converting unit that performs inverse conversion on the noise-reduced signal, based on the color space conversion method.

A third aspect of the present invention relates to a computer-readable recording medium having recorded therein a video signal processing program for performing signal processing on an inputted color video signal on a frame-by-frame basis, the video signal processing program causing a computer to perform:

a first color space conversion step of performing color space conversion on the color video signal and thereby generating a first color converted signal;

a second color space conversion step of performing color space conversion on a color video signal of a past frame and thereby generating a second color converted signal, the past frame being any frame previous to a target frame to be processed in the first color space conversion step;

a color space conversion method determination step of determining a color space conversion method which is performed in the first color space conversion step and the second color space conversion step;

a noise reduction step of performing a noise reduction process based on the first color converted signal and the second color converted signal, and thereby generating a noise-reduced signal; and

an inverse color space conversion step of performing inverse conversion on the noise-reduced signal, based on the color space conversion method determined in the color space conversion method determining step.

A fourth aspect of the present invention relates to a computer-readable recording medium having recorded therein a video signal processing program for performing signal processing on an inputted color video signal, the video signal processing program causing a computer to perform:

a color space conversion method determination step of determining a color space conversion method for the color video signal;

a color space conversion step of converting the color video signal using the color space conversion method determined in the color space conversion method determination step, and thereby generating a color converted signal;

a noise reduction step of performing a noise reduction process based on the color space conversion method and the color converted signal, and thereby generating a noise-reduced signal; and

an inverse color space conversion step of performing inverse conversion on the noise-reduced signal, based on the color space conversion method.

### BRIEF DESCRIPTION OF DRAWINGS

FIG. 1 A diagram showing a schematic configuration of a video signal processing apparatus according to a first embodiment of the present invention.

FIG. 2 A diagram showing a schematic configuration of a noise reducing unit shown in FIG. 1.

FIG. 3 A diagram for describing a color space conversion process.

FIG. 4 A diagram showing a schematic configuration of a color space conversion method determining unit shown in FIG. 1.

FIG. 5 A diagram showing a schematic configuration of a principal color determining unit shown in FIG. 4.

FIG. 6 A diagram showing a flowchart of a video signal processing program according to the first embodiment of the present invention.

FIG. 7 A diagram showing a flowchart of the video signal processing program according to the first embodiment of the present invention.

FIG. 8 A diagram showing a schematic configuration of a video signal processing apparatus according to a second embodiment of the present invention.

FIG. 9 A diagram showing a flowchart of a video signal processing program according to the second embodiment of the present invention.

### EXPLANATION OF REFERENCE

101 and 501: Input unit
102: First color space converting unit
103 and 505: Noise reducing unit
104 and 502: Buffer
105 and 503: Color space conversion method determining unit
106: Second color space converting unit
107 and 506: Inverse color space converting unit
108 and 507: Output unit
109: Control unit
110: External I/F unit
201: Motion detecting unit
202: Weight determining unit
203: Frame combining unit
301: Principal color determining unit
302: Orthogonal axis determining unit
303: Conversion function determining unit
401: Principal component analyzing unit
504: Color space converting unit

### BEST MODE FOR CARRYING OUT THE INVENTION

Embodiments of a video signal processing apparatus and a video signal processing program according to the present invention will be described below with reference to the drawings.

### First Embodiment

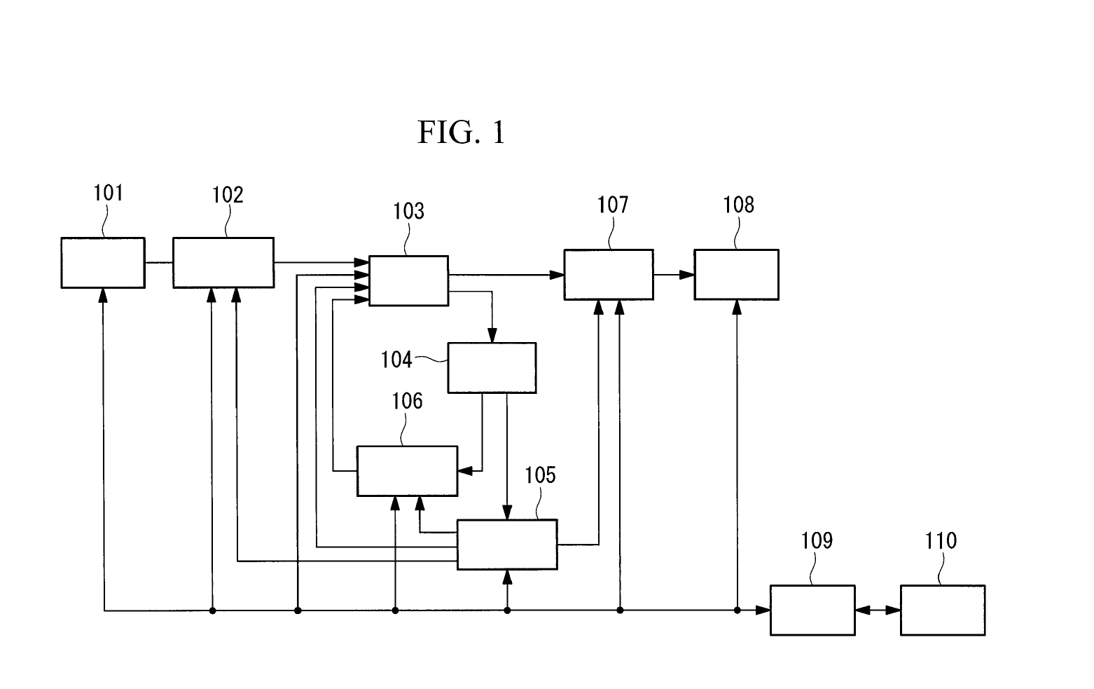

FIG. 1 is a block diagram showing a schematic configuration of a video signal processing apparatus according to the present embodiment.

As shown in FIG. 1, the video signal processing apparatus according to the present embodiment includes, as main components, a first color space converting unit 102 that performs color space conversion on a color video signal inputted through an input unit 101 and thereby generates a first color converted signal; a second color space converting unit 106 that performs color space conversion on a color video signal of a past frame which is any frame previous to a target frame to be processed in the first color space converting unit 102, and thereby generates a second color converted signal; a color space conversion method determining unit 105 that determines a color space conversion method to be performed by the first color space converting unit 102 and the second color space converting unit 106; a noise reducing unit 103 that performs a noise reduction process based on the first color converted signal and the second color converted signal, and thereby generates a noise-reduced signal; and an inverse color space converting unit 107 that performs inverse conversion on the noise-reduced signal, based on the color space conversion method determined by the color space conversion method determining unit 105.

The above-described units are connected to a control unit 109, and are activated based on control instructions from the control unit 109. The control unit 109 is connected to an external interface unit (hereinafter, referred to as “external I/F unit”) 110 which is used by a user to input, for example, power on/off and switching of various modes upon noise reduction.

When the first color space converting unit 102 accepts as input a color video signal which is inputted through the input unit 101 and which is represented in a color space of R (red), G (green), and B (blue), the first color space converting unit 102 performs a color space conversion process on the color video signal and thereby generates a first color converted signal. Specifically, the first color space converting unit 102 converts the color space {R, G, B} of the color video signal to a color space Tᵢ {Tᵢ⁰, Tᵢ¹, Tᵢ²}, using the following equation (1). The color space Tᵢ {Tᵢ⁰, Tᵢ¹, Tᵢ²} is a color space identified by a color space axis of a principal color in a video signal of an immediately previous frame and color space axes orthogonal to the color space axis of the principal color, and is determined by the color space conversion method determining unit 105 which will be described later.

$$( \begin{matrix}{T}_{i}^{0} \\ {T}_{i}^{1} \\ {T}_{i}^{2}\end{matrix} ) = ( \begin{matrix}{C}_{i}^{00} & {C}_{i}^{01} & {C}_{i}^{02} \\ {C}_{i}^{10} & {C}_{i}^{11} & {C}_{i}^{12} \\ {C}_{i}^{20} & {C}_{i}^{21} & {C}_{i}^{22}\end{matrix} ) ( \begin{matrix}R \\ G \\ B\end{matrix} ) \\ {T}_{i} = ( \begin{matrix}{T}_{i}^{0} \\ {T}_{i}^{1} \\ {T}_{i}^{2}\end{matrix} ) , {C}_{i} = ( \begin{matrix}{C}_{i}^{00} & {C}_{i}^{01} & {C}_{i}^{02} \\ {C}_{i}^{10} & {C}_{i}^{11} & {C}_{i}^{12} \\ {C}_{i}^{20} & {C}_{i}^{21} & {C}_{i}^{22}\end{matrix} ) \qquad ( 1 )$$

In the above equation (1), Cᵢ is the first color conversion function and is determined by the color space conversion method determining unit 105 which will be described later; and i is the frame number. The first color converted signal generated by the first color space converting unit 102 is transferred to the noise reducing unit 103.

The second color space converting unit 106 performs a color space conversion process on a video signal (noise-reduced signal) of an immediately previous frame which is stored in a buffer 104, and thereby generates a second color converted signal. Specifically, the second color space converting unit 106 converts a color space Tᵢ₋₁ {Tᵢ₋₁⁰, Tᵢ₋₁¹, Tᵢ₋₁²} of a video signal of an immediately previous frame to a color space Tᵢ {Tᵢ⁰, Tᵢ¹, Tᵢ²}, using the following equation (2).

Note that although in the present embodiment a color space conversion process is performed on a video signal of an immediately previous frame stored in the buffer 104, the configuration is not limited thereto and a color space conversion process may be performed on a color video signal of a past frame which is any frame previous to a frame of a target color video signal to be processed in the first color space converting unit 102.

$$( \begin{matrix}{T}_{i}^{0} \\ {T}_{i}^{1} \\ {T}_{i}^{2}\end{matrix} ) = ( \begin{matrix}{D}_{i}^{00} & {D}_{i}^{01} & {D}_{i}^{02} \\ {D}_{i}^{10} & {D}_{i}^{11} & {D}_{i}^{12} \\ {D}_{i}^{20} & {D}_{i}^{21} & {D}_{i}^{22}\end{matrix} ) ( \begin{matrix}{T}_{i - 1}^{0} \\ {T}_{i - 1}^{1} \\ {T}_{i - 1}^{2}\end{matrix} ) \\ {T}_{i - 1} = ( \begin{matrix}{T}_{i - 1}^{0} \\ {T}_{i - 1}^{1} \\ {T}_{i - 1}^{2}\end{matrix} ) , {T}_{i} = ( \begin{matrix}{T}_{i}^{0} \\ {T}_{i}^{1} \\ {T}_{i}^{2}\end{matrix} ) , {D}_{i} = ( \begin{matrix}{D}_{i}^{00} & {D}_{i}^{01} & {D}_{i}^{02} \\ {D}_{i}^{10} & {D}_{i}^{11} & {D}_{i}^{12} \\ {D}_{i}^{20} & {D}_{i}^{21} & {D}_{i}^{22}\end{matrix} ) \qquad ( 2 )$$

In equation (2), Dᵢ is the second color conversion function and is determined by the color space conversion method determining unit 105 which will be described later. The second color converted signal generated by the second color space converting unit 106 is transferred to the noise reducing unit 103.

The noise reducing unit 103 performs a noise reduction process based on the first color converted signal transferred from the first color space converting unit 102 and the second color converted signal transferred from the second color space converting unit 106, and thereby generates a noise-reduced signal and transfers the noise-reduced signal to the buffer 104 and the inverse color space converting unit 107.

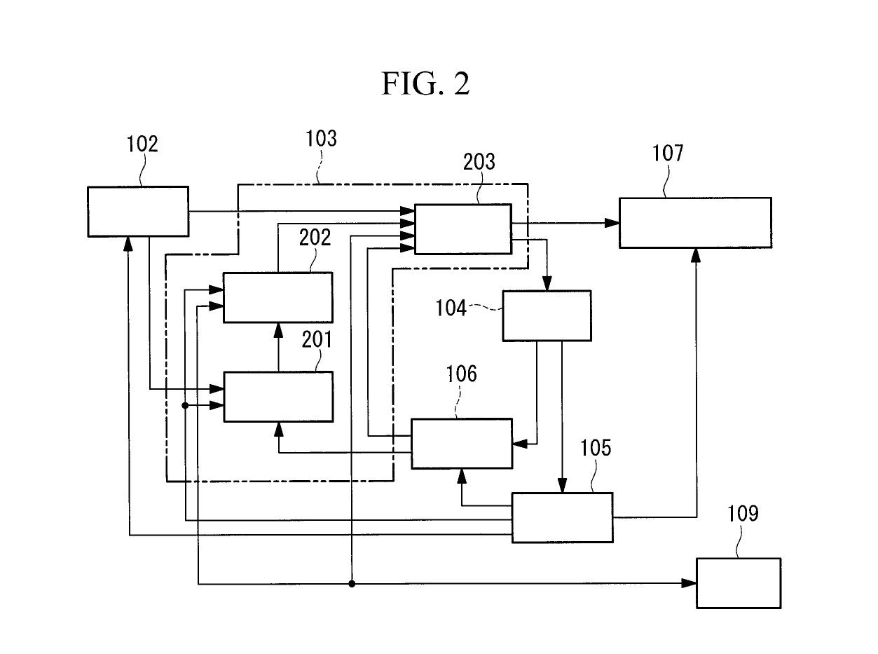

The noise reducing unit 103 will be described in detail below with reference to FIG. 2.

FIG. 2 is a diagram showing a schematic configuration of the noise reducing unit 103. As shown in FIG. 2, the noise reducing unit 103 includes a motion detecting unit 201, a weight determining unit 202, and a frame combining unit 203.

The motion detecting unit 201 computes, for each color space, a difference (the amount of motion) between a first color converted signal transferred from the first color space converting unit 102 (a video signal of a current frame having been subjected to color space conversion) and a second color converted signal transferred from the second color space converting unit 106 (a video signal of an immediately previous frame having been subjected to a noise reduction process and a color space conversion process), to determine whether there is motion from the previous frame. A determination as to whether there is motion is made as follows. For example, an absolute value of a difference between a previous frame and a current frame is determined. If the absolute value is greater than a preset threshold value, then it is determined that there is motion. Note that the threshold value or the method of determining whether there is motion may be allowed to be inputted through the external I/F unit 110 or may be preset in the control unit 109.

The weight determining unit 202 determines a weight coefficient K which is used when the first color converted signal and the second color converted signal are combined, based on motion determination information obtained by the motion detecting unit 201. For example, when the motion detecting unit 201 determines that there is motion, the weight determining unit 202 sets a high weight coefficient (e.g., 0.5 or higher).

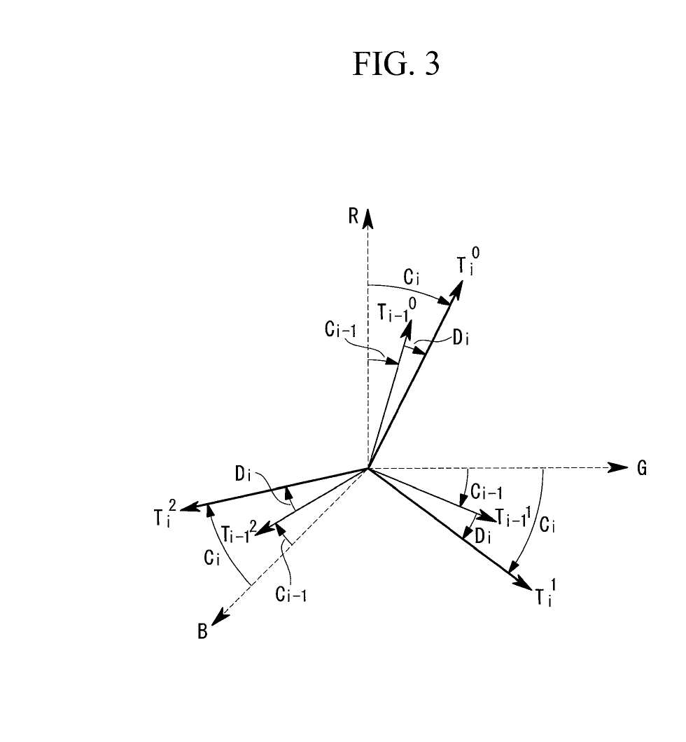

Furthermore, the weight determining unit 202 adjusts the weight coefficient K, based on an angle formed by information about a color space which is determined by the color space conversion method determining unit 105 which will be described later, and a color space axis on which great importance is placed and which is registered in advance. For example, as shown in FIG. 3, an R color space axis is registered in advance as a color space axis on which great importance is placed. When the color space axes of the first color converted signal are Tᵢ⁰, Tᵢ¹, and Tᵢ², the weight coefficient K is adjusted according to an angle formed by the R color space axis which is registered in advance and the converted color space axis Tᵢ⁰.

Furthermore, the weight determining unit 202 may set different amounts of adjustment to the weight coefficient K for the color space axis Tᵢ⁰ of the principal color and the color space axes Tᵢ¹ and Tᵢ² of those colors other than the principal color. For example, a low weight coefficient K is set for the color space axis Tᵢ⁰ of the principal color and a high weight coefficient K is set for other color space axes Tᵢ¹ and Tᵢ². Alternatively, in the other way around, a high weight coefficient K may be set for the color space axis Tᵢ⁰ of the principal color and a low weight coefficient K may be set for other color space axes Tᵢ¹ and Tᵢ².

The frame combining unit 203 combines the first color converted signal and the second color converted signal using the weight coefficient K determined by the weight determining unit 202, and thereby reduces noise and outputs a noise-reduced signal. The noise-reduced signal is given by, for example, the following equation (3):

Noise-reduced signal=(1−K)*first color converted signal+K*second color converted signal (3).

The video signal having been subjected to a noise reduction process in this manner is transferred, as a noise-reduced signal, to the inverse color space converting unit 107 and the buffer 104. The noise-reduced signal stored in the buffer 104 is used as a video signal of an immediately previous frame, by the second color space converting unit 106 and the color space conversion method determining unit 105.

The inverse color space converting unit 107 performs an inverse color conversion process on the noise-reduced signal transferred from the noise reducing unit 103, using an inverse color conversion function determined by the color space conversion method determining unit 105. Accordingly, the noise-reduced signal is converted to a signal of a color space which is defined by the color space axes of three colors, R, G, and B. The processed video signal is transferred to an output unit 108 and the video signal is recorded and saved in a recording medium such as a memory card.

The color space conversion method determining unit 105 determines, based on the noise-reduced signal stored in the buffer 104, a first color conversion function to be used by the first color space converting unit 102, a second color conversion function to be used by the second color space converting unit 106, and an inverse color conversion function to be used by the inverse color space converting unit 107, and transfers the conversion functions to the respective relevant units.

The color space conversion method determining unit 105 will be described in detail below with reference to the drawings.

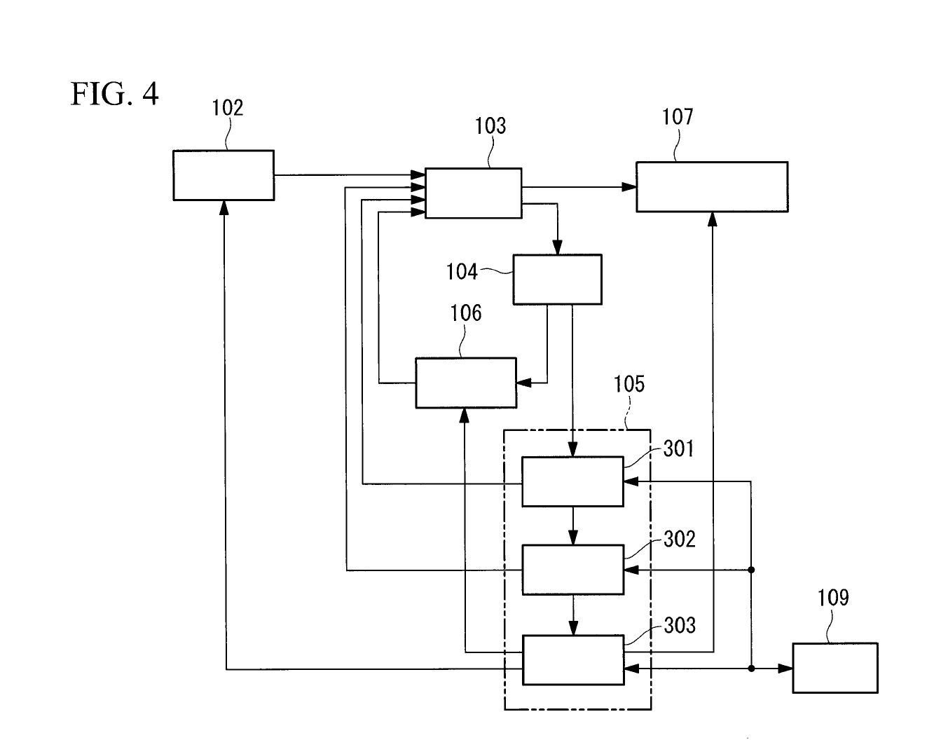

FIG. 4 is a diagram showing a schematic configuration of the color space conversion method determining unit 105. As shown in FIG. 4, the color space conversion method determining unit 105 includes a principal color determining unit 301, an orthogonal axis determining unit 302, and a conversion function determining unit 303.

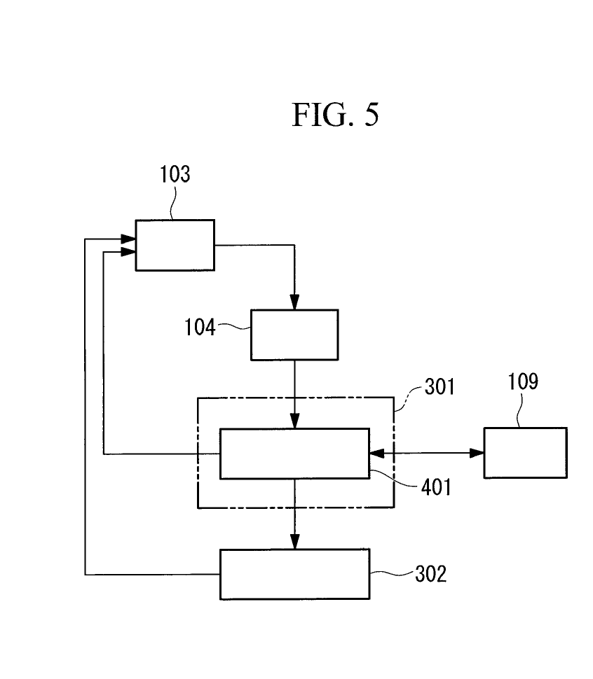

As shown in FIG. 5, the principal color determining unit 301 includes a principal component analyzing unit 401. The principal component analyzing unit 401 performs a known principal component analysis on a video signal of an immediately previous frame which is transferred from the buffer 104, and thereby determines the resulting principal component as the most important color (principal color). Note that in addition to the method of determining a principal color by the principal component analyzing unit 401, for example, the user may be allowed to specify a principal color through the external I/F unit 110.

The orthogonal axis determining unit 302 determines any two color space axes which are orthogonal, in the color space, to the principal color determined by the principal color determining unit 301. Note that the two color space axes are also orthogonal to each other.

The conversion function determining unit 303 calculates a first color conversion function Cᵢ to be used by the first color space converting unit 102, a second color conversion function Dᵢ to be used by the second color space converting unit 106, and an inverse color space function to be used by the inverse color space converting unit 107, based on the color space axis of the principal color determined by the principal color determining unit 301, and the two color space axes determined by the orthogonal axis determining unit 302.

First, the conversion function determining unit 303 determines a second color conversion function Dᵢ. The second color conversion function Dᵢ (see the above equation (2)) is determined by, for example, making the covariance matrix of a color space Tᵢ₋₁ uncorrelated which is identified by the color space axis of the principal color and the two color space axes orthogonal to the color space axis of the principal color which are determined by the principal color determining unit 301 and the orthogonal axis determining unit 302.

Subsequently, the conversion function determining unit 303 substitutes the determined second color conversion function Dᵢ into the following equation (4) and thereby determines a first color conversion function Cᵢ.

$$( \begin{matrix}{C}_{i}^{00} & {C}_{i}^{01} & {C}_{i}^{02} \\ {C}_{i}^{10} & {C}_{i}^{11} & {C}_{i}^{12} \\ {C}_{i}^{20} & {C}_{i}^{21} & {C}_{i}^{22}\end{matrix} ) = ( \begin{matrix}{D}_{i}^{00} & {D}_{i}^{01} & {D}_{i}^{02} \\ {D}_{i}^{10} & {D}_{i}^{11} & {D}_{i}^{12} \\ {D}_{i}^{20} & {D}_{i}^{21} & {D}_{i}^{22}\end{matrix} ) ( \begin{matrix}{D}_{i - 1}^{00} & {D}_{i - 1}^{01} & {D}_{i - 1}^{02} \\ {D}_{i - 1}^{10} & {D}_{i - 1}^{11} & {D}_{i - 1}^{12} \\ {D}_{i - 1}^{20} & {D}_{i - 1}^{21} & {D}_{i - 1}^{22}\end{matrix} ) … ( \begin{matrix}{D}_{1}^{00} & {D}_{1}^{01} & {D}_{1}^{02} \\ {D}_{1}^{10} & {D}_{1}^{11} & {D}_{1}^{12} \\ {D}_{1}^{20} & {D}_{1}^{21} & {D}_{1}^{22}\end{matrix} ) \qquad ( 4 )$$

In equation (4), i is the frame number.

Note that as can be seen from equation (4) the first color conversion function Cᵢ is determined recursively. Thus, the conversion function determining unit 303 can easily determine a first color conversion function to be used by the first color space converting unit 102, by recording the calculated Cᵢ and calculating Cᵢ₊₁=Dᵢ₊₁+Cᵢ when calculating a color conversion function for a next frame i+1.

The conversion function determining unit 303 transfers the first color conversion function Cᵢ to the first color space converting unit 102, and the second color conversion function Dᵢ to the second color space converting unit 106. Furthermore, the conversion function determining unit 303 determines an inverse matrix of the first color conversion function Cᵢ and transfers the inverse matrix to the inverse color space converting unit 107, as an inverse color conversion function.

Next, the actions of the video signal processing apparatus according to the present embodiment will be described briefly.

First, a video signal inputted through the input unit 101 is transferred to the first color space converting unit 102. At this time, in the case of the first frame, since a noise-reduced signal is not stored in the buffer 104, the first color space converting unit 102 does not perform color conversion but transfers the video signal as it is which is defined by its original color space, i.e., the space axes of three RGB colors, to the noise reducing unit 103. The noise reducing unit 103 does not perform a noise reduction process, either, but outputs the video signal in its original state to the buffer 104 and the inverse color space converting unit 107.

The video signal of the first frame stored in the buffer 104 is read by the color space conversion method determining unit 105. In the color space conversion method determining unit 105, the principal color determining unit 301 shown in FIG. 4 determines a principal color of the video signal of the first frame, and the orthogonal axis determining unit 302 determines two orthogonal color space axes which are orthogonal to the color space axis of the principal color. Then, the conversion function determining unit 303 determines a second color conversion function Dᵢ which is used to convert the color space of the video signal of the first frame to a color space defined by the color space axis of the principal color, etc., and determines a first color conversion function Cᵢ and an inverse color conversion function, using the second color conversion function Dᵢ. The color conversion functions are transferred to and used by their respective relevant units.

The first color space converting unit 102 performs color conversion on an RGB video signal of the second frame inputted through the input unit 101, using the first color conversion function Cᵢ provided from the color space conversion method determining unit 105, and transfers a first color converted signal to the noise reducing unit 103. The second color space converting unit 106 performs color conversion on the video signal of the first frame stored in the buffer 104, using the second color conversion function Dᵢ, and transfers a second color converted signal to the noise reducing unit 103. Accordingly, the video signal of the first frame having been converted to a color space defined by the principal color of the first frame and the video signal of the second frame are inputted to the noise reducing unit 103.

In the noise reducing unit 103, the motion detecting unit 201 shown in FIG. 2 detects a difference in motion between the first color converted signal and the second color converted signal. The weight determining unit 202 determines a weight coefficient K which is used to combine the video signal of the first frame and the video signal of the second frame, based on the amount of motion and the color space axes. The frame combining unit 203 combines the first color converted signal and the second color converted signal using the weight coefficient K, and thereby generates a noise-reduced signal. The noise-reduced signal is transferred to the buffer 104 and the inverse color space converting unit 107.

The inverse color space converting unit 107 performs an inverse color conversion process on the noise-reduced signal using the inverse color conversion function, and thereby brings the noise-reduced signal back to a video signal of its original RGB color space axes, and records and saves the video signal in a recording medium, such as a memory card, through the output unit 108. On the other hand, the noise-reduced signal transferred to the buffer 104 is read by the color space conversion method determining unit 105 and the second color space converting unit 106 and used in a noise reduction process for the third frame.

Then, by repeating the above-described process, video signals to be inputted through the input unit 101 are subjected to a noise reduction process on a frame-by-frame basis and outputted through the output unit 108.

As described above, according to the video signal processing apparatus according to the present embodiment, inputted color video signals are converted to an appropriate color space on a frame-by-frame basis and are subjected to noise reduction. Thus, for example, a noise reduction process can be performed using different amounts of noise reduction for a principal color and other colors. Accordingly, a noise reduction process taking into account an important color component can be performed, enabling to obtain an excellent image. As a result, high-quality video signals can be obtained.

Note that, instead of the above-described noise reduction method, a known noise reduction method can also be used. For example, in the case of using a smoothing filter, the noise reducing unit 103 changes the amount of noise reduction by changing a characteristic such as the coefficient or size of the smoothing filter based on the amount of motion and the color space axes.

In addition, according to the video signal processing apparatus according to the present embodiment, since a weight coefficient K is determined based on the amount of motion, noise reduction taking into account a change in scene can be performed. Furthermore, since the weight coefficient K is adjusted according to the difference between a color on which great importance is placed and which is registered in advance and a principal color determined in a video signal of an immediately previous frame, more subjectively desirable video signals can be obtained.

Note that although in the present embodiment the input and output signals are RGB video signals, the signals are not limited thereto and other signals, e.g., YCbCr signals, may be used.

Note also that although in the above-described embodiment as the video signal processing apparatus the process by hardware is premised, the configuration is not limited thereto. For example, additionally, a configuration in which the process is performed by software is also possible. In this case, a video signal processing apparatus includes a CPU, a main storage apparatus such as a RAM, and a computer-readable recording medium having recorded therein a program for implementing all or part of the above-described process. Then, the CPU reads the program recorded in the recording medium and performs an information processing and computation process and thereby implements the same process as that implemented by the above-described video signal processing apparatus.

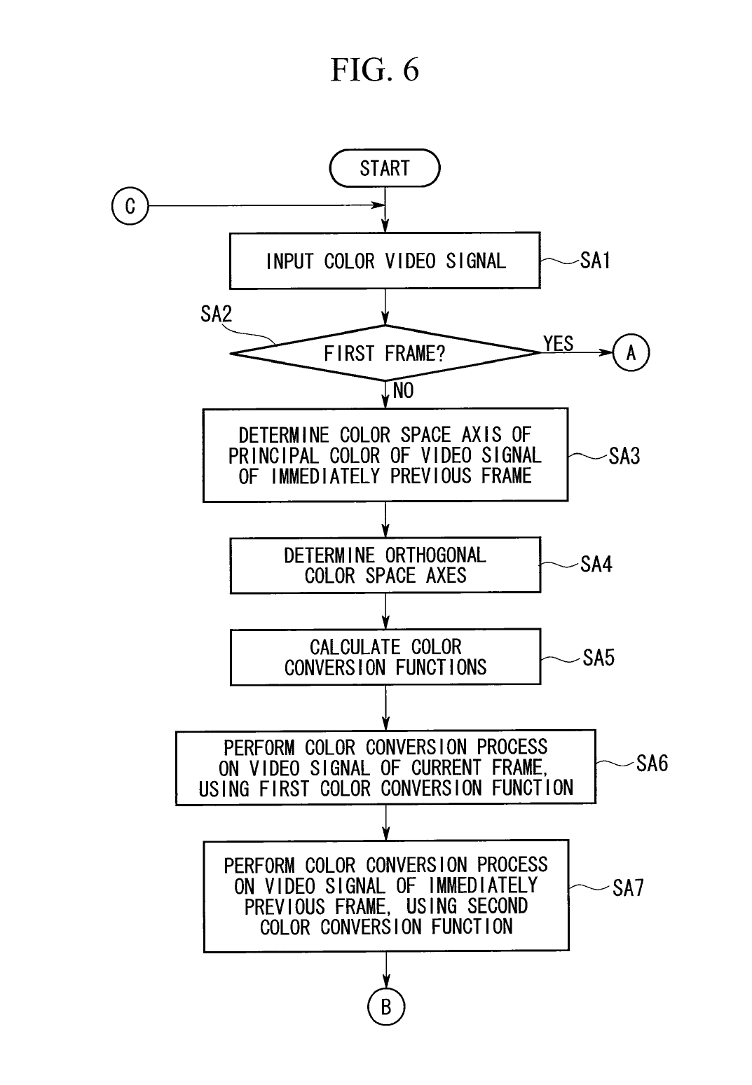

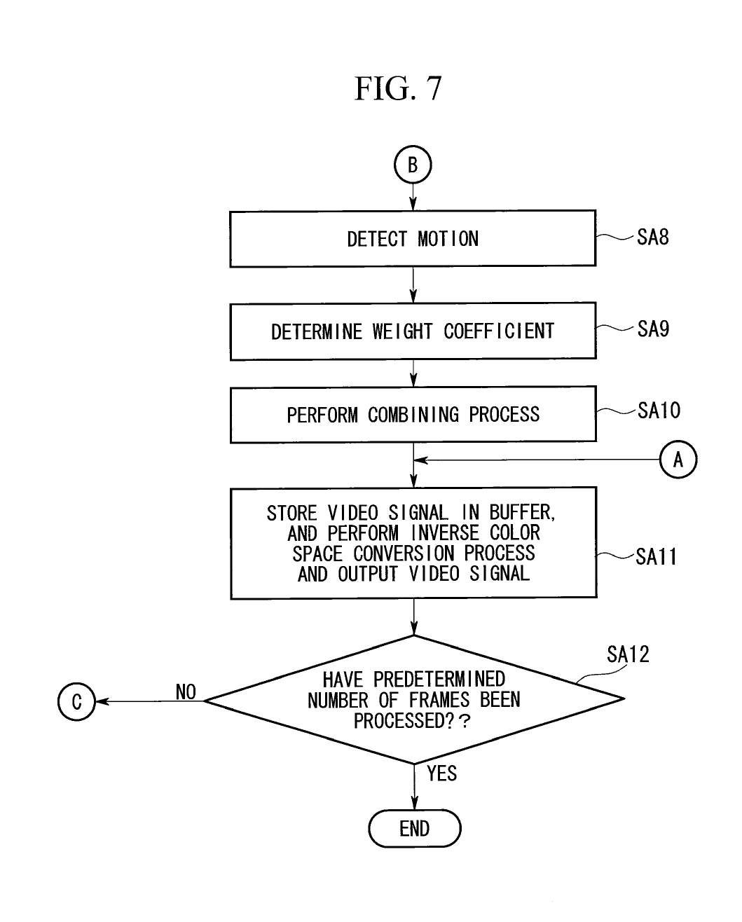

A processing procedure of a video signal processing method which is implemented by the CPU executing a video signal processing program will be described below with reference to FIGS. 6 and 7.

First, when, in step SA1 in FIG. 6, a color video signal and header information are inputted, it is determined in step SA2 whether the inputted color video signal is of the first frame. If the color video signal is of the first frame, then processing transitions to step SA11 in FIG. 7 and the video signal of the first frame is stored in the buffer and also the video signal is outputted.

Then, if it is determined in step SA2 in FIG. 6 that the color video signal is of the second or subsequent frame, then in subsequent step SA3 a color space axis of a principal color is determined based on a video signal of an immediately previous frame which is stored in the buffer. In subsequent step SA4, orthogonal color space axes which are orthogonal to the color space axis of the principal color are determined. Then, in step SA5, a first color conversion function, a second color conversion function, and an inverse color conversion function are calculated.

Subsequently, in step SA6, the color space of the current video signal is converted using the first color conversion function, whereby a first color converted signal is generated. In step SA7, the color space of the video signal of an immediately previous frame stored in the buffer is converted using the second color conversion function, whereby a second color converted signal is generated.

Then, in step SA8 in FIG. 7, motion detection is performed using the first color converted signal and the second color converted signal. In step SA9, a weight coefficient for combining is determined based on information about the amount of motion detected and the color space axes. Then, in step SA10, the first color converted signal and the second color converted signal are combined using the weight coefficient determined in step SA9, whereby a noise-reduced signal is generated. In step SA11, the noise-reduced signal is stored in the buffer, and also the noise-reduced signal is subjected to inverse conversion, whereby the noise-reduced signal is brought back to a video signal of its original color space, and then the video signal is outputted.

Then, in step SA12, it is determined whether a predetermined number of frames have been processed. If not processed, then processing returns to step SA1 in FIG. 6 and the above-described process is repeated. On the other hand, if processed, then the process ends.

### Second Embodiment

Next, a second embodiment of the present invention will be described using the drawings.

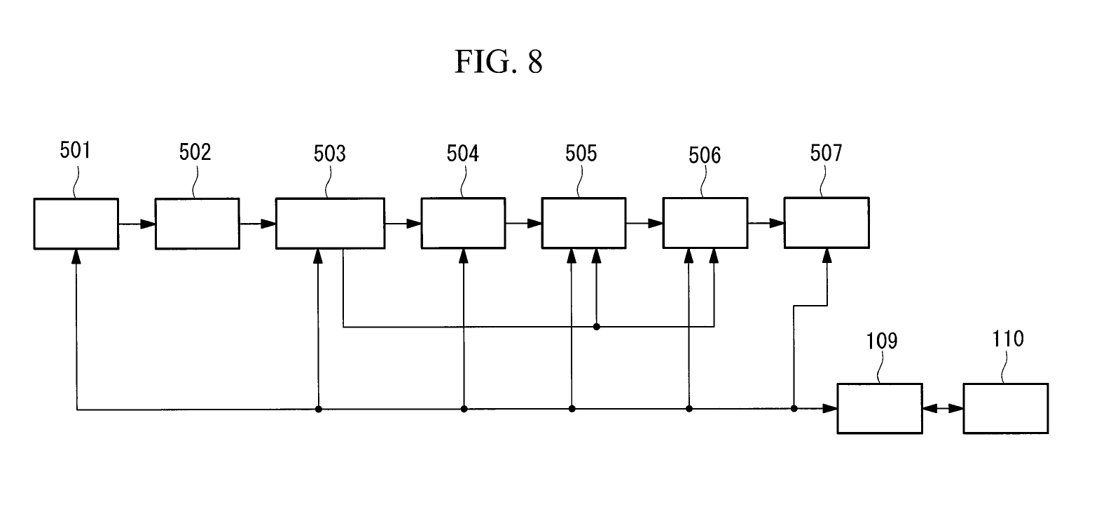

FIG. 8 is a diagram showing a schematic configuration of a video signal processing apparatus according to the present embodiment. The video signal processing apparatus according to the present embodiment performs signal processing on an inputted color video signal. The video signal processing apparatus includes, as main components, a color space conversion method determining unit 503 that determines a color space conversion method for a color video signal; a color space converting unit 504 that converts the color video signal using the color space conversion method which is determined by the color space conversion method determining unit 503, and thereby generates a color converted signal; a noise reducing unit 505 that performs a noise reduction process based on the color space conversion method and the color converted signal, and thereby generates a noise-reduced signal; and an inverse color space converting unit 506 that converts the noise-reduced signal, based on the color space conversion method.

In the video signal processing apparatus having such a configuration, a video signal inputted through an input unit 501 is stored in a buffer 502. The color space conversion method determining unit 503 has the same configuration as that in the above-described first embodiment. That is, the color space conversion method determining unit 503 reads a video signal of a current frame stored in the buffer 502 and determines a color space axis of a principal color in the video signal and two orthogonal color space axes which are orthogonal to the color space axis of the principal color, and determines a color conversion function which is used to convert the video signal of the current frame to a color space defined by the color space axes. How to determine the color conversion function is the same as how to determine a second color conversion function according to the first embodiment. In addition, the color space conversion method determining unit 503 calculates an inverse matrix of the color conversion function and uses the inverse matrix as an inverse color conversion function.

The color conversion function determined by the color space conversion method determining unit 503 is transferred to the color space converting unit 504, together with the video signal of the current frame. Information about the inverse conversion function is transferred to the inverse color space converting unit 506.

The color space converting unit 504 converts the color space of the video signal of the current frame using the color conversion function, and transfers the converted video signal to the noise reducing unit 505.

The noise reducing unit 505 performs noise reduction, based on the color space converted video signal which is transferred from the color space converting unit 504. For example, the noise reducing unit 505 changes the amount of noise reduction by changing a characteristic such as the coefficient or size of a smoothing filter using information about the color space. At this time, different amounts of noise reduction may be set for a principal color which is registered in advance and other colors.

Note that, instead of the above-described noise reduction method, for example, a known noise reduction method which is specified by a user through an external I/F unit 110 may be used. The noise-reduced video signal is transferred to the inverse color space converting unit 506.

The inverse color space converting unit 506 performs inverse color space conversion on the video signal transferred from the noise reducing unit 505, using the inverse color conversion function provided from the color space conversion method determining unit 503. Accordingly, the color space of the noise-reduced video signal is brought back to its original color space obtained at the time of input. The color space converted video signal is transferred to an output unit 507 and is recorded and saved in a recording medium such as a memory card.

As described above, according to the video signal processing apparatus according to the present embodiment, the color space conversion method determining unit 503 determines a color space of a principal color based on a color video signal of a current frame, and determines a color conversion function for the color space. The color space converting unit 504 converts the color space of the video signal of the current frame, using the color conversion function which is determined by the color space conversion method determining unit 503. Then, based on the converted video signal, a noise reduction process is performed. As such, since a color video signal is converted to an appropriate color space and different amounts of noise reduction are set for a principal color and other colors, an appropriate noise reduction process can be performed according to a color. Accordingly, an image with a desired quality can be obtained.

Note that although in the above-described embodiment the process by hardware is premised, the configuration is not limited thereto. Additionally, a configuration in which the process is performed by software is also possible.

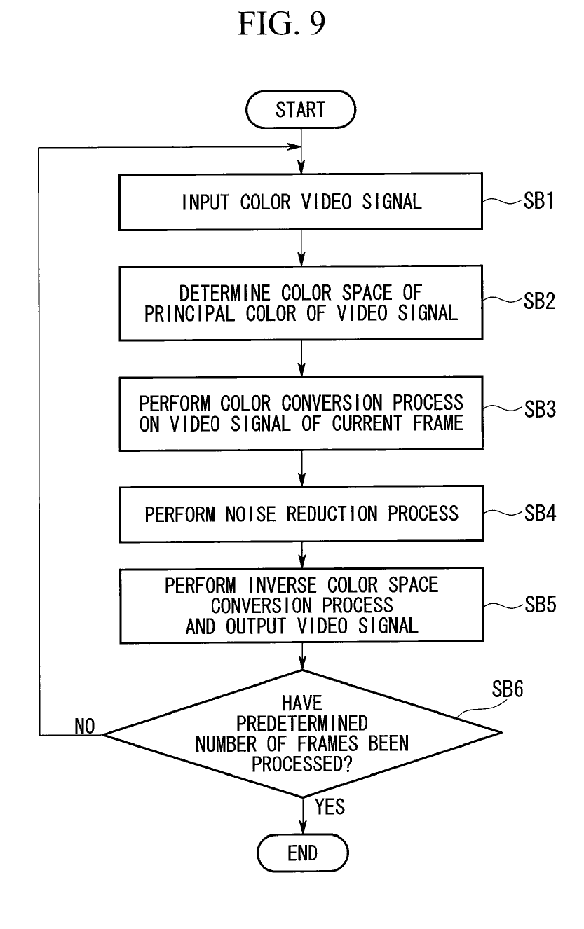

FIG. 9 is a flowchart showing a processing procedure of a video signal processing program according to the present embodiment.

First, when, in step SB1, a color video signal and header information are inputted, in step SB2 a color space of the video signal is determined. In step SB3, the color space of the video signal is converted. In step SB4, a noise reduction process is performed based on the color space converted video signal. In step SB5, the noise-reduced video signal is subjected to inverse color conversion, whereby the noise-reduced video signal is brought back to its original color space of a video signal obtained at the time of input, and then the video signal is outputted.

In step SB6, it is determined whether a predetermined number of frames have been processed. If not processed, then processing returns to step SB1 and the above-described process is repeated. On the other hand, if processed, then the process ends.

1. A video signal processing apparatus that performs signal processing on an inputted color video signal on a frame-by-frame basis, the video signal processing apparatus comprising:
a first color space converting unit that performs color space conversion on the color video signal and thereby generates a first color converted signal;
a second color space converting unit that performs color space conversion on a color video signal of a past frame and thereby generates a second color converted signal, the past frame being any frame previous to a target frame to be processed in the first color space converting unit;
a color space conversion method determining unit that determines a color space conversion method which is performed by the first color space converting unit and the second color space converting unit;
a noise reducing unit that performs a noise reduction process based on the first color converted signal and the second color converted signal, and thereby generates a noise-reduced signal; and
an inverse color space converting unit that performs inverse conversion on the noise-reduced signal, on the basis of the color space conversion method determined by the color space conversion method determining unit.

2. The video signal processing apparatus according to claim 1, wherein
the color space conversion method determining unit includes:
a principal color determining unit that determines at least one important principal color in the color video signal of the past frame;
an orthogonal axis determining unit that determines color space axes orthogonal to a color space axis representing the principal color which is determined by the principal color determining unit; and
a conversion function determining unit that computes a function used to convert the color video signal to a color space including the color space axis representing the principal color which is determined by the principal color determining unit, and the color space axes which are determined by the orthogonal axis determining unit.

3. The video signal processing apparatus according to claim 2, wherein the principal color determining unit includes a principal component analyzing unit that performs a principal component analysis on the color video signal of the past frame and thereby determines the principal color.

4. The video signal processing apparatus according to claim 2, wherein the noise reducing unit includes:
a motion detecting unit that detects an amount of motion by a difference between the first color converted signal and the second color converted signal;
a weight determining unit that determines a weight coefficient used when the first color converted signal and the second color converted signal are combined, on the basis of the amount of motion and the color space axes determined by the color space conversion method determining unit; and
a frame combining unit that combines the first color converted signal and the second color converted signal, using the weight coefficient determined by the weight determining unit.

5. The video signal processing apparatus according to claim 4, wherein the weight determining unit determines the weight coefficient, according to an angle formed by the color space axis representing the principal color which is determined by the principal color determining unit, and a preset color space axis on which great importance is placed.

6. The video signal processing apparatus according to claim 2, wherein the noise reducing unit determines a level of the noise reduction process, according to an angle formed by the color space axis representing the principal color which is determined by the principal color determining unit, and a preset color space axis on which great importance is placed.

7. A video signal processing apparatus that performs signal processing on an inputted color video signal, the video signal processing apparatus comprising:
a color space conversion method determining unit that determines a color space conversion method for the color video signal;
a color space converting unit that converts the color video signal using the color space conversion method determined by the color space conversion method determining unit, and thereby generates a color converted signal;
a noise reducing unit that performs a noise reduction process based on the color space conversion method and the color converted signal, and thereby generates a noise-reduced signal; and
an inverse color space converting unit that performs inverse conversion on the noise-reduced signal, on the basis of the color space conversion method.

8. The video signal processing apparatus according to claim 7, wherein
the color space conversion method determining unit includes:
a principal color determining unit that determines at least one important principal color in the color video signal;
an orthogonal axis determining unit that determines color space axes orthogonal to a color space axis representing the color which is determined by the principal color determining unit; and
a conversion function determining unit that computes a function used to convert the color video signal to a color space including the color space axis representing the color which is determined by the principal color determining unit, and the color space axes which are determined by the orthogonal axis determining unit, and
determines the color space conversion method by the function.

9. The video signal processing apparatus according to claim 8, wherein the principal color determining unit includes a principal component analyzing unit that performs a principal component analysis on the color video signal and thereby determines a color space axis of the principal color.

10. The video signal processing apparatus according to claim 9, wherein the noise reducing unit changes a level of noise reduction, according to an angle formed by the color space axis representing the principal color which is determined by the principal color determining unit, and a preset color space axis on which great importance is placed.

11. A computer-readable recording medium having recorded therein a video signal processing program for performing signal processing on an inputted color video signal on a frame-by-frame basis, the video signal processing program causing a computer to perform:
a first color space conversion step of performing color space conversion on the color video signal and thereby generating a first color converted signal;
a second color space conversion step of performing color space conversion on a color video signal of a past frame and thereby generating a second color converted signal, the past frame being any frame previous to a target frame to be processed in the first color space conversion step;
a color space conversion method determination step of determining a color space conversion method which is performed in the first color space conversion step and the second color space conversion step;
a noise reduction step of performing a noise reduction process based on the first color converted signal and the second color converted signal, and thereby generating a noise-reduced signal; and
an inverse color space conversion step of performing inverse conversion on the noise-reduced signal, based on the color space conversion method determined in the color space conversion method determining step.

12. The computer-readable recording medium having recorded therein a video signal processing program according to claim 11, wherein
the color space conversion method determination step includes:
a principal color determination step of determining at least one important principal color in the video signal of the past frame;
an orthogonal axis determination step of determining color space axes orthogonal to a color space axis representing the principal color which is determined in the principal color determination step; and
a conversion function determination step of computing a function used to convert the color video signal to a color space including the color space axis representing the principal color which is determined in the principal color determination step, and the color space axes which are determined in the orthogonal axis determination step.

13. The computer-readable recording medium having recorded therein a video signal processing program according to claim 12, wherein the principal color determination step includes a principal component analysis step of performing a principal component analysis on the color video signal of the past frame and thereby determining the principal color.

14. The computer-readable recording medium having recorded therein a video signal processing program according to claim 12, wherein the noise reduction step includes:
a motion detection step of detecting an amount of motion by a difference between the first color converted signal and the second color converted signal;
a weight determination step of determining a weight coefficient used when the first color converted signal and the second color converted signal are combined, based on the amount of motion and the color space axes determined in the color space conversion method determination step; and
a frame combining step of combining the first color converted signal and the second color converted signal, using the weight coefficient determined in the weight determination step.

15. A computer-readable recording medium having recorded therein a video signal processing program for performing signal processing on an inputted color video signal, the video signal processing program causing a computer to perform:
a color space conversion method determination step of determining a color space conversion method for the color video signal;
a color space conversion step of converting the color video signal using the color space conversion method determined in the color space conversion method determination step, and thereby generating a color converted signal;
a noise reduction step of performing a noise reduction process based on the color space conversion method and the color converted signal, and thereby generating a noise-reduced signal; and
an inverse color space conversion step of performing inverse conversion on the noise-reduced signal, based on the color space conversion method.

16. The computer-readable recording medium having recorded therein a video signal processing program according to claim 15, wherein
the color space conversion method determination step includes:
a principal color determination step of determining at least one important principal color in the color video signal;
an orthogonal axis determination step of determining color space axes orthogonal to a color space axis representing the color which is determined in the principal color determination step; and
a conversion function determination step of computing a function used to convert the color video signal to a color space including the color space axis representing the color which is determined in the principal color determination step, and the color space axes which are determined in the orthogonal axis determination step, and
in the color space conversion method determination step, the color space conversion method is determined by the function.

17. The computer-readable recording medium having recorded therein a video signal processing program according to claim 16, wherein the principal color determination step includes a principal component analysis step of performing a principal component analysis on the color video signal and thereby determining a color space axis of the principal color.
